(19) United States
(12) Patent Application Publication
(10) Pub. No.: US 2019/0058279 A1
(43) Pub. Date: Feb. 21, 2019

(54) PLUG CONNECTOR MODULE HAVING A DETACHABLE FLOATING CONNECTOR ASSEMBLY

(71) Applicant: FOXCONN INTERCONNECT TECHNOLOGY LIMITED, Grand Cayman (KY)

(72) Inventors: JERRY WU, Irvine, CA (US); JUN CHEN, Kunshan (CN); FAN-BO MENG, Kunshan (CN)

(21) Appl. No.: 16/104,562

(22) Filed: Aug. 17, 2018

(30) Foreign Application Priority Data
Aug. 17, 2017 (CN) 201710706348.6

(51) Int. Cl. H01R 13/514; H01R 13/62; H01R 43/20; H01R 27/02

(52) U.S. Cl. CPC H01R 13/514; H01R 27/02; H01R 43/20; H01R 13/6205

(57) ABSTRACT

A plug connector module (100) includes a first electrical connector assembly (10) and a second electrical connector (20). The first electrical connector assembly includes a first outer shell (11) and a first mating member (12) mounted on the first outer shell for being mated with a first mating connector. The second electrical connector assembly includes a second outer shell (21) and a second mating member (22) mounted on the second outer shell for being mated with a second mating connector. The first outer shell is detachably mated with the second outer shell that to allow the first electrical connector assembly and the second electrical connector assembly to be used as assembled together or be used separately after being disassembled.

### BACKGROUND OF THE INVENTION

### Field of the Invention

The present invention relates to a plug connector module, and more particularly to a connector module having a versatile use.

### Description of Related Arts

U.S. Pat. No. 8,632,351, issued on Jan. 21, 2014 to Wu, discloses a connector module comprising a base, a first electrical connector assembly mounted on the base, and a second electrical connector assembly mounted on the base and disposed spaced apart from the first electrical connector assembly. The second electrical connector assembly is floating with respect to the base for easy mating with a mating connector. Both of the first electrical connector assembly and the second electrical connector assembly are fixed on the base such that they cannot be independently used.

Hence, an improved plug connector module is desired to offer advantages over the related art.

### SUMMARY OF THE INVENTION

An object of the present invention is to provide a plug connector module having a versatile use.

To achieve the above-mentioned object, a plug connector module comprises a first electrical connector assembly comprising a first outer shell and a first mating member mounted on the first outer shell for being mated with a first mating connector; and a second electrical connector assembly comprising a second outer shell and a second mating member mounted on the second outer shell for being mated with a second mating connector; wherein the first outer shell is detachably mated with the second outer shell to allow the first electrical connector assembly and the second electrical connector assembly to be used as assembled together or be used separately after being disassembled.

According to the present invention, the first outer shell is detachably mated with the second outer shell so that the first electrical connector assembly and the second electrical connector assembly can be used as assembled together or be used separately after being disassembled.

### BRIEF DESCRIPTION OF THE DRAWING

FIG. 1 is a perspective view of a plug connector module in accordance with present invention;

FIG. 2 is a part of exploded view of the plug connector module as shown in FIG. 1;

FIG. 3 is another part of exploded view of the plug connector module as shown in FIG. 2;

FIG. 4 is another part of exploded view of the plug connector module as shown in FIG. 3;

FIG. 5 is a part of exploded view of a second electrical connector assembly of the plug connector module of the connector module as shown in FIG. 1;

FIG. 6 is a part of exploded view of a first electrical connector assembly of the plug connector module of the connector module as shown in FIG. 1;

FIG. 7 is another part of exploded view of the first electrical connector assembly of the plug connector module of the connector module as shown in FIG. 6;

FIG. 8 is a cross section view of the plug connector module taken along line 8-8 of FIG. 1; and

FIG. 9 is a cross section view of the plug connector module taken along line 9-9 of FIG. 2.

### DETAILED DESCRIPTION OF THE PREFERRED EMBODIMENT

Reference will now be made in detail to a preferred embodiment of the present invention.

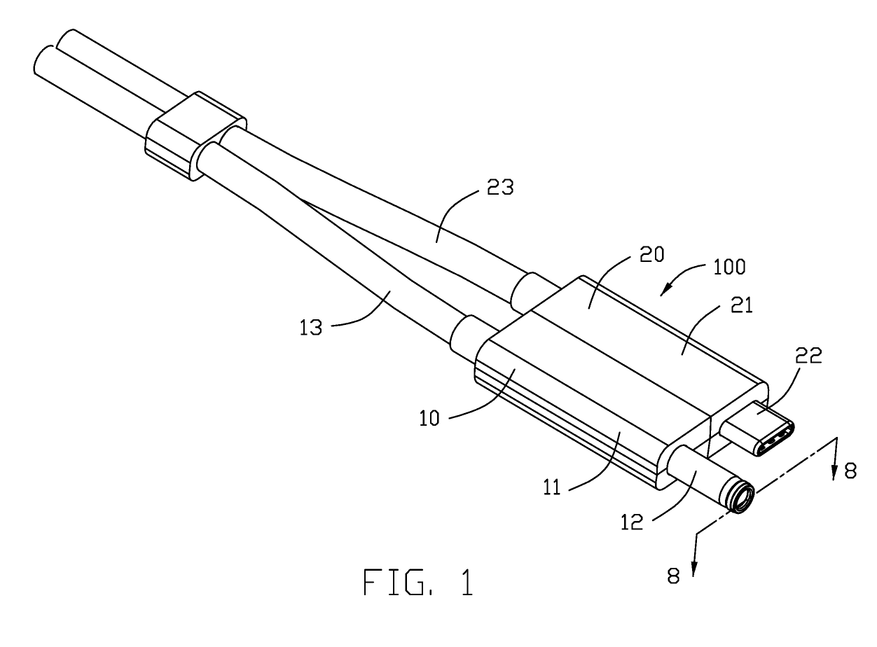

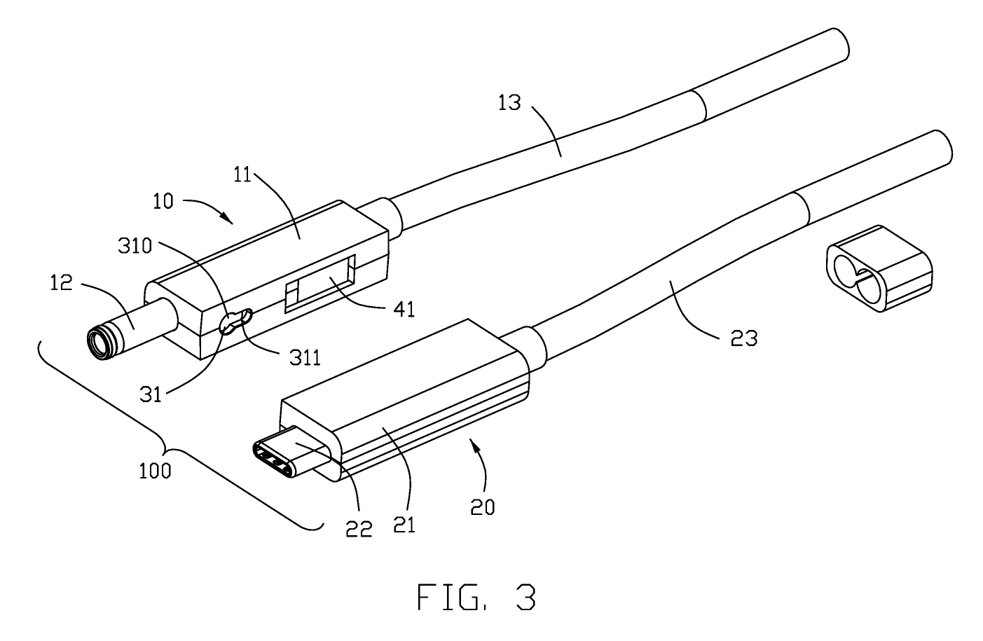

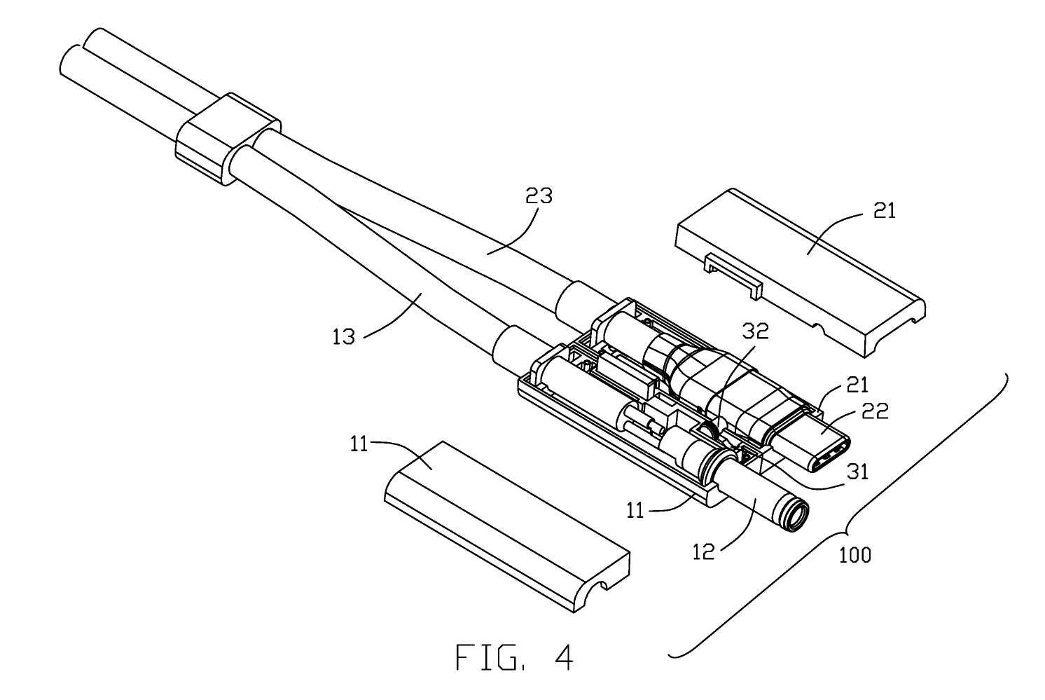

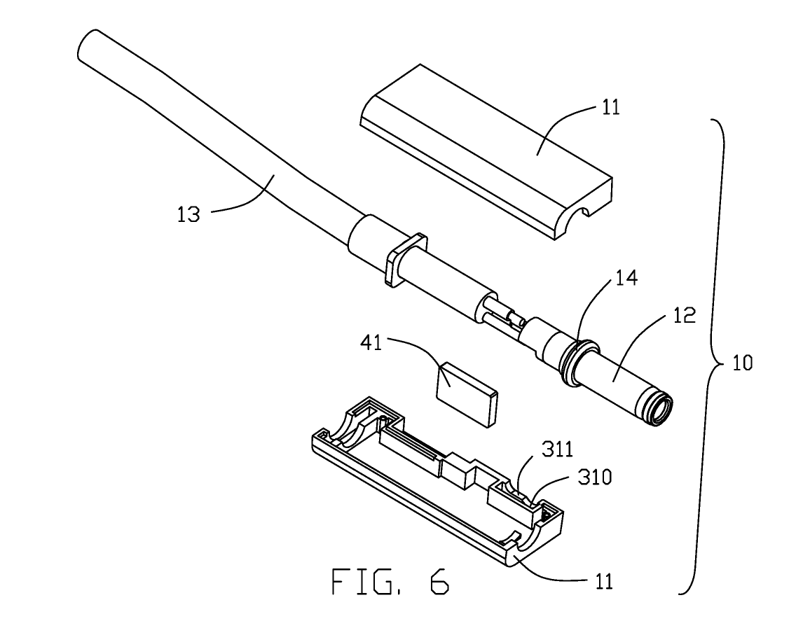

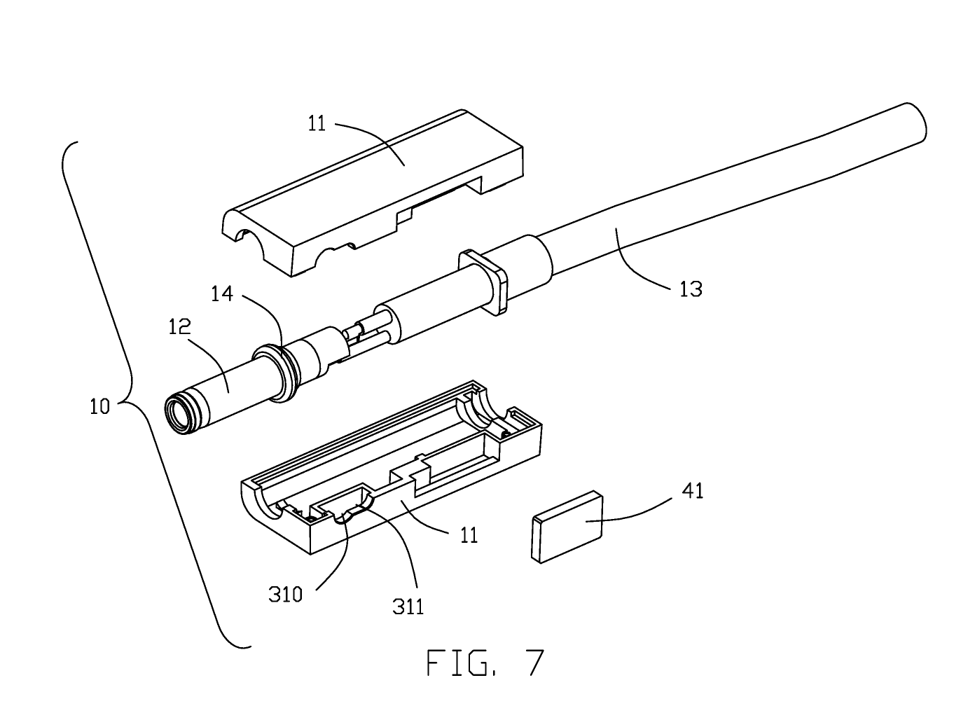

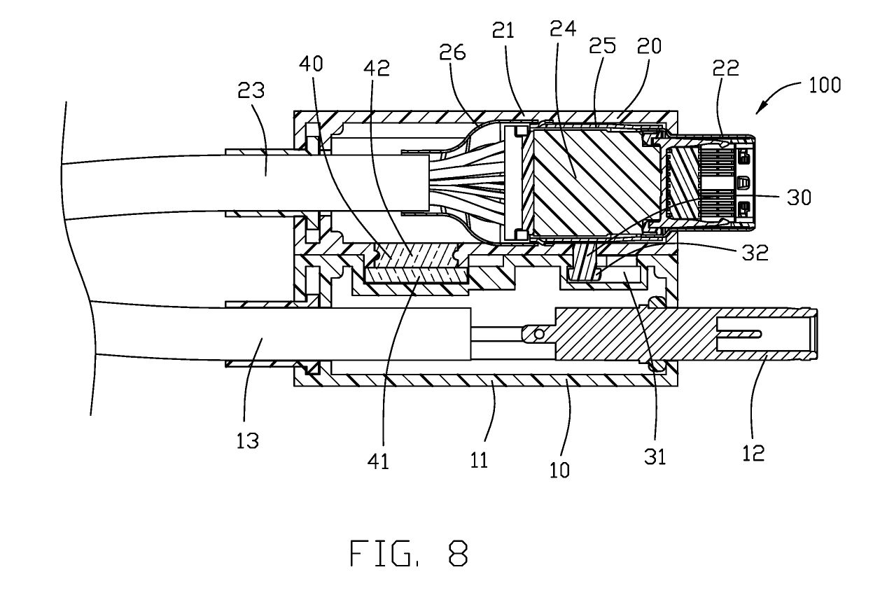

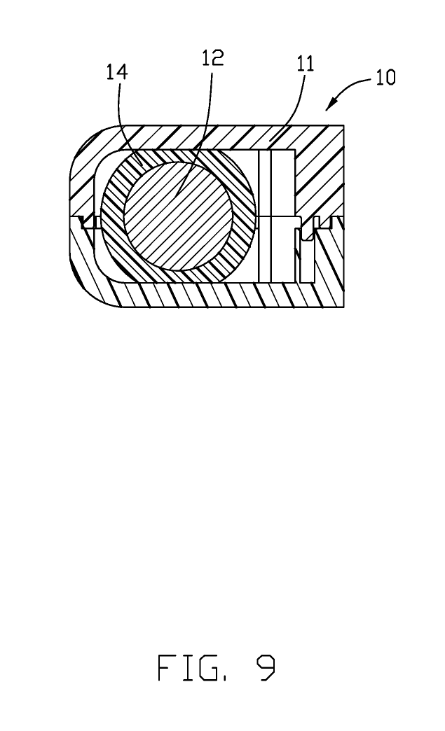

Referring to FIGS. 1 to 9, a plug connector module 100 comprises a first electrical connector assembly 10, a second electrical connector assembly 20 detachably assembled with the first electrical connector assembly 10. The first electrical connector assembly 10 comprises a first outer shell 11, a first mating member 12 mounted on the first outer shell 11 and for being mated with a first mating connector, and a first cable 13 electrically connected with the first mating member 12. The second electrical connector assembly 20 comprises a second outer shell 21, a second mating member 22 mounted on the second outer shell 21 and for being mated with a second mating connector, and a second cable 23 electrically connected with the second mating member 22.

In this embodiment, the second electrically connector assembly 20 further comprises an inner printed circuit board 24, a first metal shell 25 sleeved on an end of the second mating member 22, and a second metal shell 26 sleeved on the first metal shell 25 and the second cable 23. The inner printed circuit board 24 comprises an end mechanically and electrically connected with the second mating member 22, and an opposite end mechanically and electrically connected with the second cable 23 that establish and electrical connection between the second mating member 22 and the second cable 23. The first outer shell 11 is detachably assembled with the second outer shell 21 that make the first electrical connector assembly 10 and the second electrical connector assembly 20 detachably assembled together. Therefore, the first electrical connector assembly 10 and the second electrical connector assembly 10 can be used assembled together or be used separately after being disassembled. In this embodiment, the first electrical connector assembly 10 and the second electrical connector assembly 20 have different mating interfaces. Specifically, the first mating member 12 is a power plug supporting at least 10 A current. The second mating member 22 is in according with the USB C plug standard and supporting at least 10 Gbps per channel signal speed. In other embodiment, the first mating member 12 and the second mating member 22 may have same mating interface.

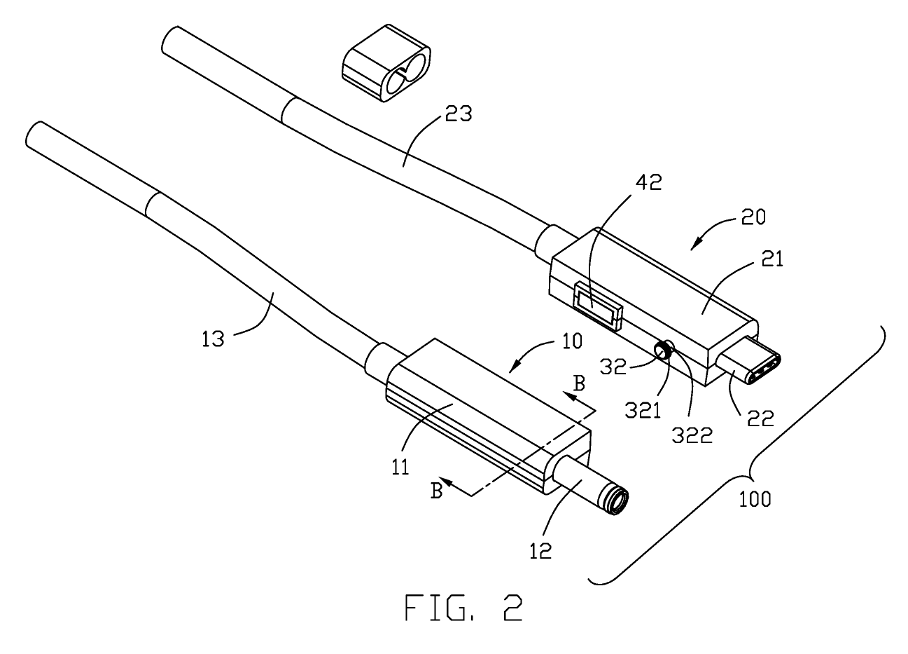

Referring to FIGS. 2 to 8, the plug connector module 100 further comprises locating mechanism 30 for ensuring positioning between the first electrical connector assembly 10 and the second electrical connector assembly 20. The locating mechanism 30 comprises a locating hole 31 defined in the first electrical connector assembly 10, and a locating post 32 located on the second electrical connector assembly 20. The locating hole 31 comprises a first hole 310 and a second hole 311 in communication with the first hole 310. The first hole 310 has a radial size greater than a radial size of the second hole 311. The locating post 32 comprises a first portion 320 and a second portion 321 located at a free end of the first portion 320. The second portion 321 has a radial size greater than a radial size of the first portion 320. The second portion 321 can enter into the locating hole 31 through the first hole 310 and slide to the second hole 311 to make the first electrical connector assembly 10 fixed with the second electrical connector assembly 20.

Referring to FIGS. 2 to 8, the plug connector module 100 further comprises a holding member 40 or ensuring the first electrical connector assembly 10 and the second electrical connector assembly 20 fixed together. The holding member 40 comprises a magnet 41 mounted on the first electrical connector assembly 10, and a magnetic part 42 mounted on the second electrical connector assembly 20 for be mated with the magnet 41. A magnetic force between the magnet 41 and the magnetic part 42 is used to provide a fixed force for keeping the first electrical connector assembly 10 fixed together with the second electrical connector assembly 20. The magnet 41 is indented in the first outer shell 11 and forming a recess, and the magnetic part 42 is projected out of the second shell 21 and received in the recess of the first shell 11. The magnet 41 may be a component that can generate a magnetic field to provide magnetic attraction. The magnetic body 42 may be a component that can generate a magnetic field to provide magnetic attraction, or a component that can be attracted by a magnetic field but does not provide a magnetic force by itself. In other embodiment, the magnet 41 can also be mounted to the second electrical connector assembly 20, and the magnetic body 42 is correspondingly mounted to the first electrical connector assembly 10.

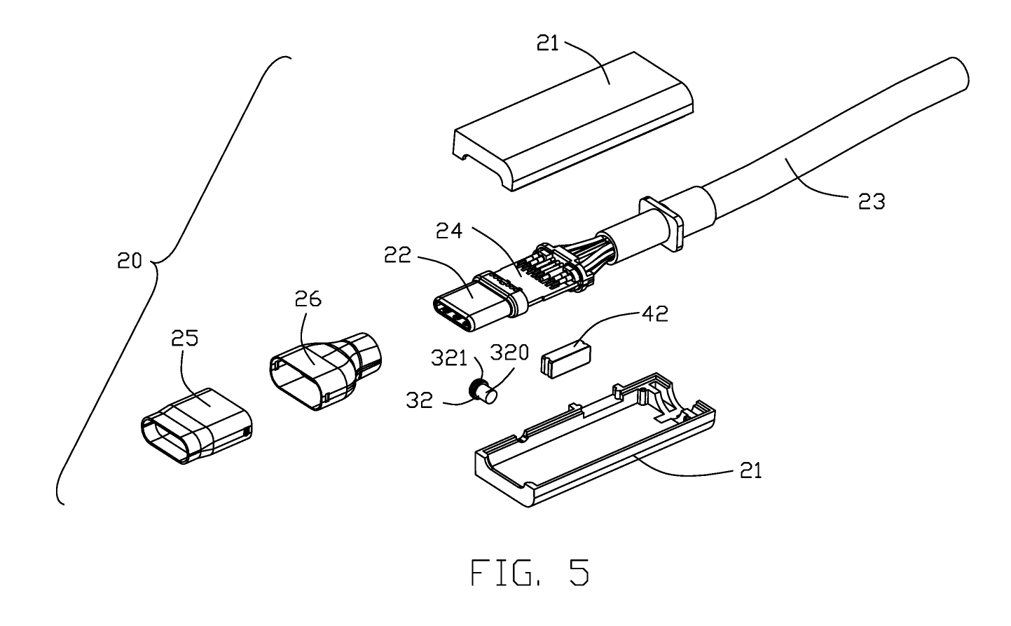

Referring to FIGS. 5 to 9, the first electrical connector assembly 10 further comprises an elastic part 14 disposed between the mating member 12 and the first outer shell 11 that provide the first mating member 12 having a floating space along a radial direction of the first electrical connector assembly 10 that provide tolerance between the first electrical connector assembly 10 and the second electrical connector assembly 20. In this embodiment, the first mating member 12 has a circular cross section. The elastic part 14 is a rubber ring and sleeved on the first mating member 12.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A plug connector module comprising:
a first electrical connector assembly comprising a first outer shell and a first mating member mounted on the first outer shell being mated with a first mating connector; and
a second electrical connector assembly comprising a second outer shell and a second mating member mounted on the second outer shell for being mated with a second mating connector; wherein
the first outer shell is detachably mated with the second outer shell to allow the first electrical connector assembly and the second electrical connector assembly to be used as assembled together or be used separately after being disassembled.

2. The plug connector module as recited in claim 1, further comprising a locating member for positioning the first electrical connector assembly with respect to the second electrical connector assembly.

3. The plug connector module as recited in claim 2, wherein the locating member comprises a locating hole defined in one of the first electrical connector assembly and the second electrical connector assembly and a locating post located on the other of the first electrical connector assembly and the second electrical connector assembly, the locating post being adapted for mating with the locating hole.

4. The plug connector module as recited in claim 1, further comprising a holding member for fixing the first electrical connector assembly and the second electrical connector assembly together.

5. The plug connector module as recited in claim 4, wherein the holding member comprises a magnet mounted on one of the first electrical connector assembly and the second electrical connector assembly and a magnetic part mounted on the other of the first electrical connector assembly and the second electrical connector assembly for mating with the magnet.

6. The plug connector module as recited in claim 1, wherein the first electrical connector assembly comprises an elastic part disposed between the first mating member and the first outer shell to provide the first mating member with a floating space along a radial direction of the first electrical connector assembly.

7. The plug connector module as recited in claim 6, wherein the elastic part is a rubber ring sleeved on the first mating member.

8. The plug connector module as recited in claim 1, wherein the first electrical connector assembly comprises a first cable electrically connected with the first mating member, and the second electrical connector comprises a second cable electrically connected with the second mating member.

9. The plug connector module as recited in claim 1, wherein the first electrical connector assembly and the second electrical connector assembly have different mating interfaces.

10. The plug connector module as recited in claim 9, wherein the first mating member is a power plug supporting at least 10 A current, and the second mating member is a USB Type-C compatible plug supporting at least 10 Gbps per channel signal speed.

11. A plug connector module comprising:
a first electrical connector assembly including a first outer shell and a first mating member received in the first outer shell being mated with a first mating connector; and
a second electrical connector assembly including a second outer shell and a second mating member received in the second outer shell for being mated with a second mating connector; wherein
the first outer shell is detachably attached to the second outer shell in two steps, of which a first step is to have the first outer shell and the second outer shell moved relatively toward each other in a transverse direction until a locating post on one of the first outer shell and the second outer shell received within a locating hole formed in the other of the first outer shell and the second outer shell, and a second step is to have the first outer shell and the second outer shell moved relatively along a front-to-back direction perpendicular to the transverse direction until the locating post can not leave the locating hole in the transverse direction.

12. The plug connector module as claimed in claim 11, further including a magnetic mechanism is located between the first outer shell and the second outer shell to keep the first outer shell and the second outer shell secured to each other not only in the front-to-back direction but also in the transverse direction.

13. The plug connector module as claimed in claim 12, wherein a front face of the first outer shell through which the first mating member extends forwardly, and another front face of the second outer shell are coplanar with each other in the transverse direction when the first outer shell and the second outer shell are located at final relative positions.

14. A method of making a plug connector module comprising steps of:
providing a first electrical connector assembly with a first outer shell enclosing a first mating member where a locating hole is formed in the first outer shell;
providing a second electrical connector assembly with a second outer shell enclosing a second mating member wherein a locating post is formed on the second outer shell;
having the first outer shell and the second outer shell moved toward each other in a transverse direction until the locating post is received within the locating hole initially, and having the first outer shell and the second outer shell moved relative to each other in a front-to-back direction perpendicular to the transverse direction until the locating pin can not leave the locating hole due to dimension change of the locating hole in the front-to-back direction.

15. The method as claimed in claim 14, wherein further including a step of providing magnetic mechanism on both the first outer shell and the second outer shell to keep both the first outer shell and the second outer shell in final relative positions in the front-to-back direction for assure retention therebetween in both the front-to-back direction and the transverse direction.

16. The method as claimed in claim 15, wherein a front face of the first outer shell is coplanar with another front face of the second outer shell when the first outer shell and the second outer shell are located in said final relative positions.
